(19) United States
(12) Patent Application Publication
(10) Pub. No.: US 2024/0045949 A1
(43) Pub. Date: Feb. 8, 2024

(54) INFORMATION COLLECTION CONTROL APPARATUS, INFORMATION COLLECTION SYSTEM, INFORMATION COLLECTION CONTROL METHOD, AND INFORMATION COLLECTION CONTROL PROGRAM

(71) Applicant: NEC Corporation, Minato-ku, Tokyo (JP)

(72) Inventors: Koki Tomita, Tokyo (JP); Norio Yamagaki, Tokyo (JP); Hirofumi Ueda, Tokyo (JP)

(73) Assignee: NEC Corporation, Minato-ku, Tokyo (JP)

(21) Appl. No.: 18/266,754

(22) PCT Filed: Dec. 23, 2020
(86) PCT No.: PCT/JP2020/048267

§ 371 Date: Jun. 12, 2023

(51) Int. Cl. G06F 21/55; G06F 21/57

(52) U.S. Cl. CPC G06F 21/552; G06F 21/577

(57) ABSTRACT

In order to reduce processing load when analyzing a security risk, an information collection control apparatus includes: a history information collecting unit configured to perform collection processing for collecting history information related to an operation history of a program operating with a terminal; and a transmission control unit configured to control a timing for transmitting the history information to a server.

### TECHNICAL FIELD

The present invention relates to an information collection control apparatus, an information collection system, an information collection control method, and an information collection control program.

### BACKGROUND ART

A recent increase of cyberattacks on systems connected to networks has led to desires to reinforce security of such systems. In order to ensure security of a system, it is necessary to take measures against cyberattacks in advance, instead of after a cyberattack on the system is executed. In order to grasp whether there is an indication of a cyberattack on and/or a security risk for equipment included in the system, monitoring of information related to operation of the equipment is needed.

As an example of a technique for monitoring information related to operation of equipment and analyzing security risks, PTL 1 proposes a technique for determining correctness of operation of a device in an analysis target system, based on system call execution information of the OS executed in the device. System call is a mechanism in which a program uses resources managed by an OS, and the system call execution information in PTL 1 includes a system call name, an argument, and the like. In PTL 1, it is determined for a device corresponding to a system call execution history matching an unauthorized pattern that there is a security problem.

### CITATION LIST

### Patent Literature

[PTL 1] JP 2019-028670 A

### SUMMARY

### Technical Problem

In the above-described technique disclosed in PTL 1, correctness of the operation of the device is determined based on the system call execution information of a system call invoked by the OS. However, since a huge number of system calls are invoked even in a short time, PTL 1 has an issue that the processing load for grasping whether there is an indication of a cyberattack and/or a security risk increases, which consequently increases cost and time required for processing for grasping whether there is an indication of a cyberattack and/or a security risk.

An example object of the present invention, which is made to solve the issues, is to reduce processing load when analyzing a security risk.

### Solution to Problem

An information collection control apparatus of the present invention includes: a history information collecting unit configured to perform collection processing for collecting history information related to an operation history of a program operating with a terminal; and a transmission control unit configured to control a timing for transmitting the history information to a server.

An information collection system of the present invention includes an information collection control apparatus including: a history information collecting unit configured to perform collection processing for collecting history information related to an operation history of a program operating with a terminal; and a transmission control unit configured to control a timing for transmitting the history information to a server.

An information collection control method of the present invention includes: performing collection processing for collecting history information related to an operation history of a program operating with a terminal; and controlling a timing for transmitting the history information to a server.

An information collection control program of the present invention causes a processor to execute: performing collection processing for collecting history information related to an operation history of a program operating with a terminal; and controlling a timing for transmitting the history information to a server.

### Advantageous Effects of Invention

According to the present invention, it is possible to reduce processing load when analyzing a security risk. Note that, according to the present invention, instead of or together with the above effects, other effects may be exerted.

### BRIEF DESCRIPTION OF THE DRAWINGS

FIG. 1 is a diagram illustrating an operation mode of an information collection system according to a first example embodiment;

FIG. 2 is a diagram illustrating a hardware configuration of an information processing apparatus according to the first example embodiment;

FIG. 3 is a functional block diagram illustrating a functional configuration of a device according to the first example embodiment;

FIG. 4 is a sequence diagram illustrating a flow of processing in the information collection system according to the first example embodiment;

FIG. 5 is a diagram illustrating a configuration of a history information data table according to the first example embodiment;

FIG. 6 is a diagram illustrating an example of information described in a danger degree configuration condition according to the first example embodiment;

FIG. 7 is a flowchart illustrating an example of a flow of danger degree configuration processing according to the first example embodiment;

FIG. 8 is a diagram illustrating another example of the information described in the danger degree configuration condition according to the first example embodiment;

FIG. 9 is a flowchart illustrating another example of the flow of the danger degree configuration processing according to the first example embodiment;

FIG. 10 is a diagram illustrating a configuration of danger degree information according to the first example embodiment;

FIG. 11 is a flowchart illustrating a flow of transmission determination processing according to the first example embodiment;

FIG. 12 is a functional block diagram illustrating a functional configuration of a device according to an example alteration of the first example embodiment;

FIG. 13 is a sequence diagram illustrating a flow of processing in the information collection system according to the example alteration of the first example embodiment;

FIG. 14 is a functional block diagram illustrating a functional configuration of a device according to a second example embodiment;

FIG. 15 is a diagram illustrating an example of information described in a danger degree configuration condition according to the second example embodiment;

FIG. 16 is a flowchart illustrating a flow of collection target optimization processing according to the second example embodiment;

FIG. 17 is a functional block diagram illustrating a functional configuration of a device according to an example alteration of the second example embodiment;

FIG. 18 is a functional block diagram illustrating a functional configuration of a server according to a third example embodiment;

FIG. 19 is a flowchart illustrating a flow of collection target optimization processing according to the third example embodiment;

FIG. 20 is a diagram illustrating an operation mode of an information collection system according to an example alteration of the third example embodiment;

FIG. 21 is a diagram illustrating an operation mode of an information collection system according to a fourth example embodiment; and

FIG. 22 is a diagram illustrating a functional configuration of an information collection control apparatus according to the fourth example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same or corresponding reference signs, and overlapping descriptions may hence be omitted.

The example embodiments to be described below are merely examples of a configuration that can implement the present invention. Modifications and changes can be appropriately made to each of the example embodiments below according to the configuration of an apparatus to which the present invention is applied and various conditions. All the combinations of the elements included in each of the example embodiments below are not necessarily essential to realizing the present invention, and part of the elements can be appropriately omitted. Hence, the scope of the present invention is not intended to be limited to the configurations described in the example embodiments below. Unless there is a mutual conflict, configurations each combining a plurality of configurations described in the example embodiments can also be adopted.

Descriptions will be given in the following order.
1. Overview of Example Embodiments of the Present Invention
2. First Example Embodiment
   2.1. Operation Mode of Information Collection System 1000
   2.2. Configuration of Device 1
      2.2.1. Hardware Configuration of Information Processing Apparatus such as Device 1
      2.2.2. Functional Configuration of Device 1
   2.3. Overview of Processing in Information Collection System 1000
      2.3.1. Flow of Processing in Information Collection System 1000
      2.3.2. Overview of Danger Degree Configuration Processing in Device 1
         2.3.2.1. Flow of Danger Degree Configuration Processing based on Danger Degree Configuration Condition in which Parameters are Described
         2.3.2.2. Flow of Danger Degree Configuration Processing based on Danger Degree Configuration Condition in which Attack Pattern is Described
      2.3.3. Flow of Transmission Determination Processing in Device 1
3. Example Alteration of First Example Embodiment
   3.1. Functional Configuration of Device 1
   3.2. Flow of Processing in Information Collection System 1000
4. Second Example Embodiment
   4.1. Functional Configuration of Device 1
   4.2. Flow of Collection Target Optimization Processing in Device 1
5. Example Alteration of Second Example Embodiment
   5.1. Functional Configuration of Device 1
6. Third Example Embodiment
   6.1. Functional Configuration of Server 2
   6.2. Flow of Collection Target Optimization Processing in Server 2
7. Example Alteration of Third Example Embodiment
8. Fourth Example Embodiment
9. Other Example Embodiments

### 1. Overview of Example Embodiments of the Present Invention

First, an overview of example embodiments of the present invention will be described.

### (1) Technical Issues

A recent increase of cyberattacks on systems connected to networks has led to desires to reinforce security of such systems. In order to ensure security of a system, it is necessary to take measures against cyberattacks in advance, instead of after a cyberattack on the system is executed. In order to grasp whether there is an indication of a cyberattack on and/or a security risk for equipment included in the system, monitoring of information related to operation of the equipment is needed.

As an example of a technique for monitoring information related to operation of equipment and analyzing security risks, there has been proposed a technique for determining correctness of operation of a device in an analysis target system, based on system call execution information of the OS executed in the device. System call is a mechanism in which a program uses resources managed by an OS, and the system call execution information in PTL 1 includes a system call name, an argument, and the like. In PTL 1, it is determined for a device corresponding to a system call execution history matching an unauthorized pattern that there is a security problem.

In this technique, correctness of the operation of the device is determined based on the system call execution information of a system call invoked by the OS. However, since a huge number of system calls are invoked even in a short time, PTL 1 has an issue that the processing load for grasping whether there is an indication of a cyberattack and/or a security risk increases, which consequently increases cost and time required for processing for grasping whether there is an indication of a cyberattack and/or a security risk.

In view of the above circumstances, the present invention has an example object to reduce processing load when analyzing a security risk.

### (2) Technical Features

In the example embodiments of the present invention, an information collection control apparatus includes: a history information collecting unit configured to perform collection processing for collecting history information related to an operation history of a program operating with a terminal; and a transmission control unit configured to control a timing for transmitting the history information to a server.

With this, it is possible to reduce processing load when analyzing a security risk. Note that the above-described technical features are concrete examples of the example embodiments of the present invention, and the example embodiments of the present invention are apparently not limited to the above-described technical features.

### 2. First Example Embodiment

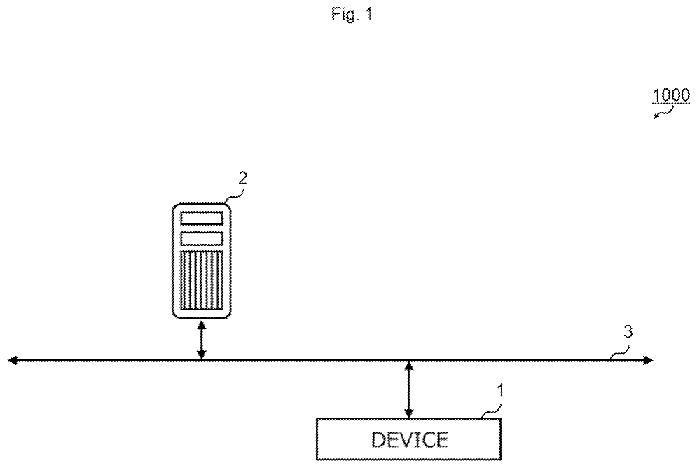

A description will be given below of a first example embodiment of the present invention with reference to FIGS. 1 to 11. In the present example embodiment, a description will be given of an information collection system 1000 including a device 1 and a server 2 and configured to transmit collected information in the device 1 to the server 2.

### <2.1. Operation Mode of Information Collection System 1000>

First, an operation mode of the information collection system 1000 according to the first example embodiment will be described. FIG. 1 is a diagram illustrating the operation mode of the information collection system 1000 according to the first example embodiment. As illustrated in FIG. 1, the information collection system 1000 is configured by the device 1 and the server 2 being connected to each other via a network 3.

The device 1 is, for example, a terminal such as a radio unit (RU) used as a slave radio station of a base station apparatus of a radio communication system. The RU converts a digital signal to a radio frequency to amplify transmit power or perform transmission and/or reception using an antenna element. A program for collecting history information related to an operation history of a program operating with the device 1 (for example, the operating system (OS) of the device 1) is installed in the device 1. Note that an information processing terminal other than the RU may be used as the device 1.

The server 2 is an information processing apparatus configured to, for example, store, analyze, and output information collected in the information collection system 1000. In the present example embodiment, the server 2 can receive history information transmitted from the device 1 and analyze a security risk in the device 1, based on the received history information.

The network 3 is a communication line connecting the device 1 and the server 2 to be able to communicate with each other and may be wired or wireless. Note that the device 1 and the server 2 need not necessarily be connected with each other all the time. It is only necessary that the device 1 and the server 2 be at least connected with each other at a timing when the history information is transmitted from the device 1.

The history information of the device 1 in the present example embodiment corresponds to information related to an operation history of a program operating with the device 1, the operation being, for example, file operation, directory operation, registry operation, thread operation, and process operation, implemented by operation of a program such as the OS of the device 1. Such an operation history can be acquired by acquiring an execution history of a system call invoked when the program operating with the device 1 uses hardware resources of the device 1. The program operating with the device 1 invokes a library function to thereby perform input/output from/to the hardware resources of the device 1 or file processing. Some of library functions may be functions indirectly using a system call to perform input/output from/to the hardware resources of the device 1 or file processing. In other words, the operation history of the device 1 as those described above can also be acquired by acquiring a history of a library function invoked by the program operating with the device 1. In the following, a history of a system call and a history of a library function(s) invoked by the program operating with the device 1 will be referred to as “history information”.

The program implemented in the device 1 executes input/output processing for input/output from/to the hardware resources configuring the device 1, by a system call or a library function(s), and consequently, a huge number of system calls are invoked in the device 1 even in a short period of time as long as the program is operating. Hence, there is an issue that the amount of processing load of the server 2 to analyze a security risk for the device 1, based on the history information of the device 1 results in being huge, which consequently increases cost and time required for processing for grasping whether there is an indication of a cyberattack and/or a security risk. To address such an issue, in the present example embodiment, a timing for transmitting the history information is controlled in the device 1 to reduce the processing load of the server 2.

### <2.2. Configuration of Device 1>

Next, a configuration of the device 1 according to the present example embodiment will be described. Here, first, after a hardware configuration of the information processing apparatuses such as the device 1 and the server 2 is described, a functional configuration of the device 1 will be described.

### <2.2.1. Hardware Configuration of Information Processing Apparatus Such as Device 1>

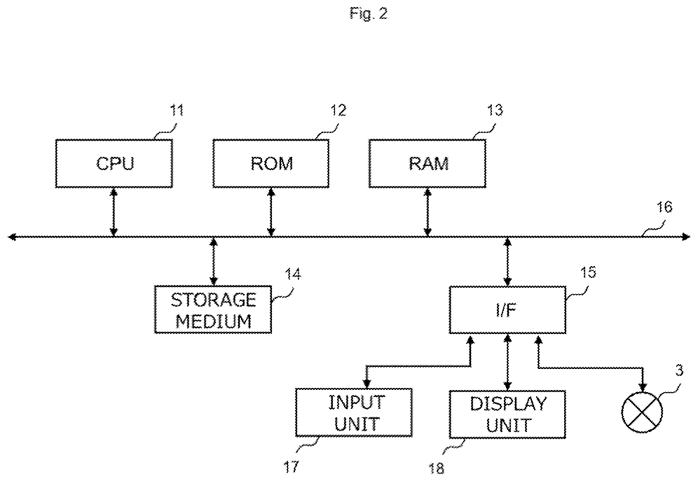

With reference to FIG. 2, the hardware configuration of the information processing apparatuses such as the device 1 and the server 2 according to the present example embodiment will be described. FIG. 2 is a block diagram illustrating a hardware configuration of an information processing apparatus.

In the information processing apparatus, a central processing unit (CPU) 11, a read only memory (ROM) 12, a random access memory (RAM) 13, a storage medium 14, and an interface (I/F) 15 are connected to each other via a bus 16. An input unit 17, a display unit 18, and the network 3 are connected to the I/F 15.

The CPU 11 is a computing means and is configured to control operation of the entire information processing apparatus. The RAM 13 is a volatile storage medium capable of high-speed reading/writing of information and is used as a work region when the CPU 11 processes information. The ROM 12 is a non-volatile read-only storage medium and is configured to store programs such as firmware therein. The storage medium 14 is a non-volatile storage medium, such as a hard disk drive (HDD), capable of reading and writing of information and is configured to store the OS, various control programs and application programs, and the like.

The I/F 15 is configured to connect and control the bus 16 and various kinds of hardware, a network, and the like. The input unit 17 is an input apparatus such as a keyboard and a mouse for a user to input information to the information processing apparatus. The display unit 18 is a display apparatus, such as a liquid crystal display (LCD), for the user to check a state of the information processing apparatus. Note that the input unit 17 and the display unit 18 can be omitted.

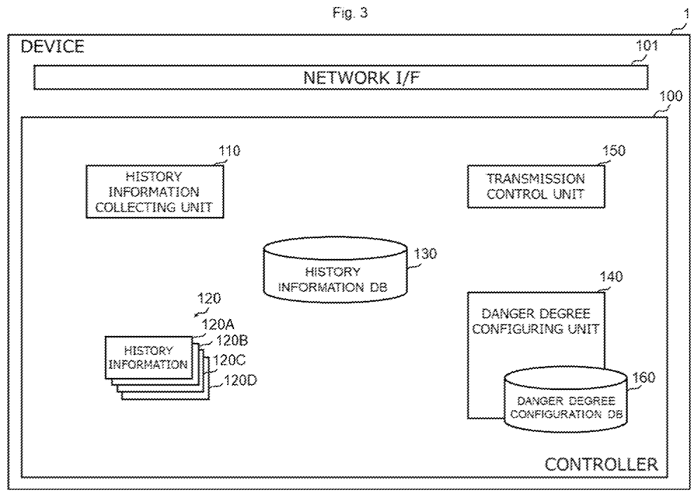

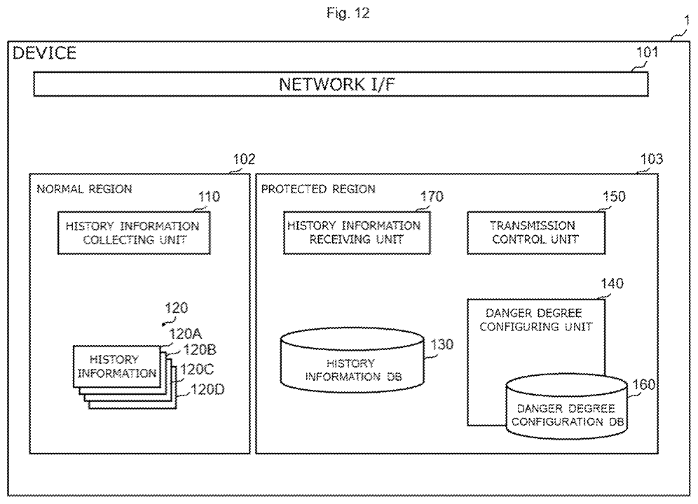

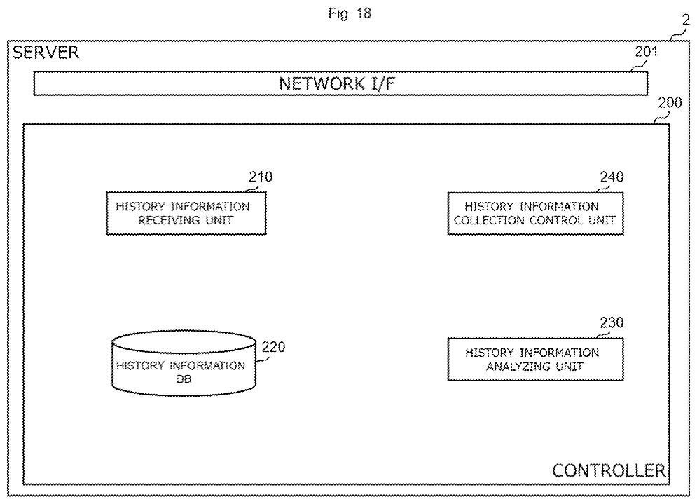

In such a hardware configuration, the CPU 11 performs computing in accordance with the programs stored in the ROM 12 and programs loaded into the RAM 13 from the storage medium 14, to thereby configure a software control unit of the information processing apparatus. By combining the software control unit thus configured and the hardware, a functional block implementing functions of the information processing apparatus such as a controller 100 (refer to FIG. 3), a normal region 102, and a protected region 103 (refer to FIG. 12) of the device 1 according to the present example embodiment, and a controller 200 (refer to FIG. 18) of the server 2, is configured.

### <2.2.2. Functional Configuration of Device 1>

Next, with reference to FIG. 3, a functional configuration of the device 1 will be described. FIG. 3 is a functional block diagram illustrating the functional configuration of the device 1. As illustrated in FIG. 3, the device 1 includes the controller 100 and a network T/F 101.

The controller 100 is configured to acquire history information of a program operating with the device 1, configure danger degree related to the degree of security risk of the device 1, control transmission of history information to the server 2, and the like. The controller 100 is configured by a dedicated software program being installed in the device 1. This software program corresponds to an information collection control program of the present example embodiment. The controller 100 includes a history information collecting unit 110, a history information data base (DB) 130, a danger degree configuring unit 140, a transmission control unit 150, and a danger degree configuration data base (DB) 160.

The history information collecting unit 110 executes collection processing for collecting pieces of history information 120A, 120B, 120C, and 120D related to operation histories of programs operating with the device 1. In the following, the pieces of history information 120A, 120B, 120C, and 120D will be referred to collectively as “history information 120” to continue the description, unless otherwise distinguished.

The history information DB 130 is a storage region in which the history information 120 collected by the history information collecting unit 110 is stored. A configuration of information stored in the history information DB 130 will be described later.

The danger degree configuring unit 140 executes danger degree configuration processing for configuring danger degree related to the degree of security risk in the device 1, for the history information 120 collected by the history information collecting unit 110. The danger degree related to the degree of security risk corresponds to a risk index indicating the degree of security risk in a terminal such as the device 1, defined based on a security vulnerability evaluation or the like.

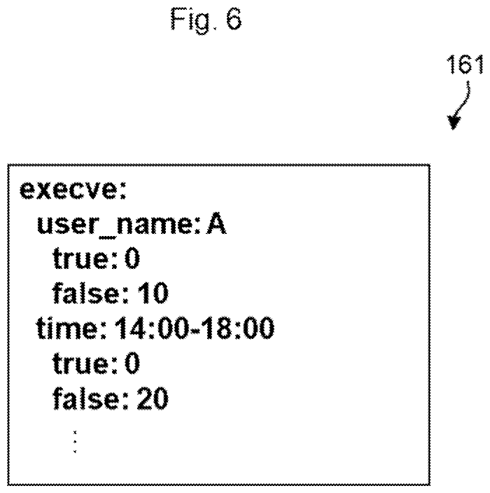

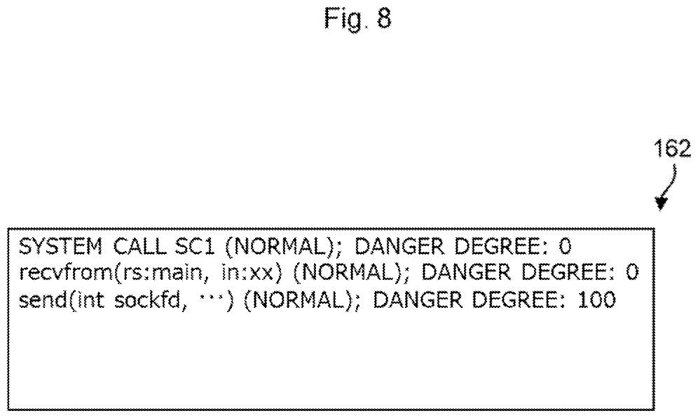

The danger degree configuring unit 140 configures danger degree for each of the pieces of history information 120A, 120B, 120C, and 120D, based on danger degree configuration conditions 161 and 162 (refer to FIGS. 6 and 8) defined based on a security vulnerability evaluation, a history of past cyberattacks, and the like. The danger degree information related to the danger degree configured by the danger degree configuring unit 140 is stored in the danger degree configuration DB 160. Details of the danger degree configuration processing performed by the danger degree configuring unit 140 will be described below with reference to FIGS. 6 to 10.

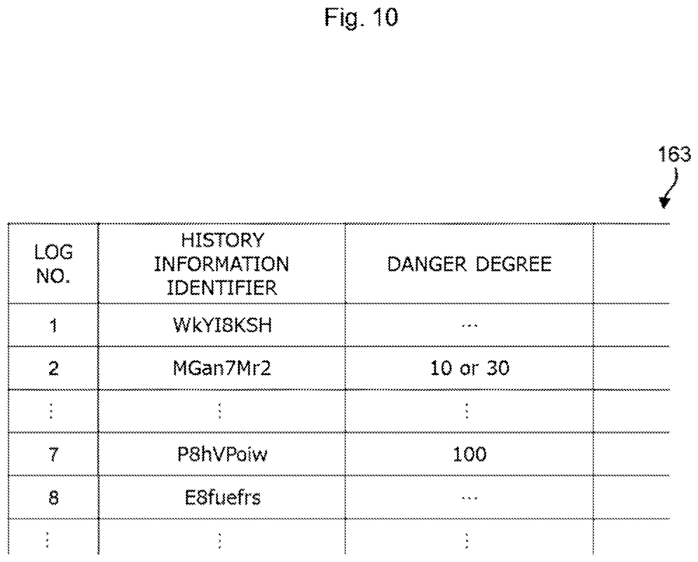

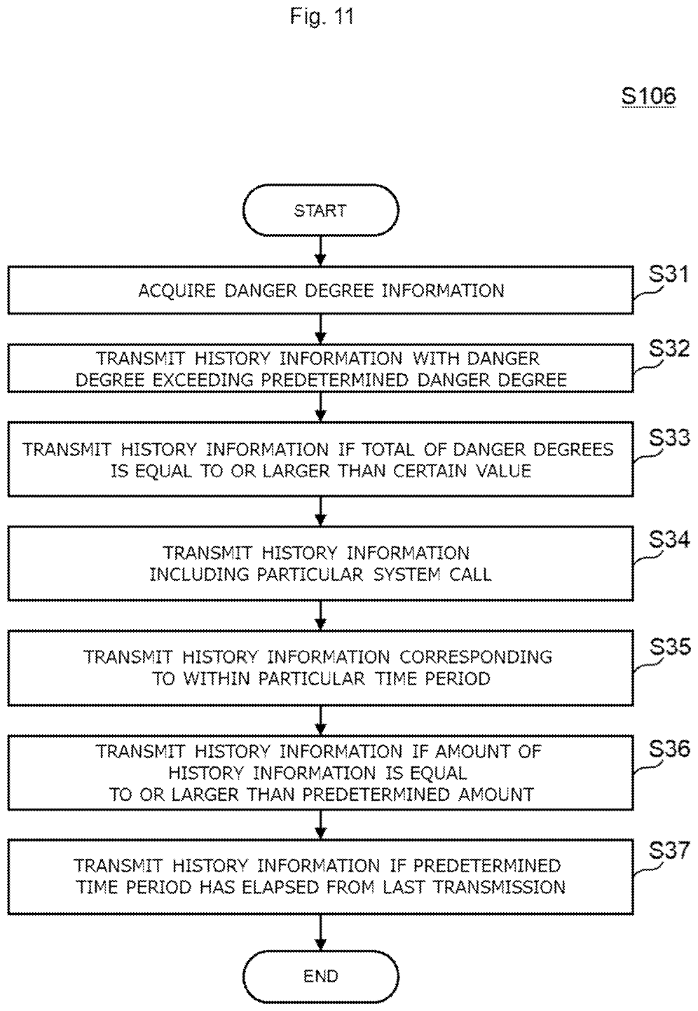

The transmission control unit 150 executes transmission determination processing for controlling a timing for transmitting the history information to the server 2. Details of the transmission determination processing performed by the transmission control unit 150 will be described later with reference to FIGS. 10 and 11.

With the configuration described above, the device 1 acquires the history information 120 related to an operation history of the program operating with the device 1 and controls a transmission timing for transmitting the acquired history information 120 to the server 2.

### <2.3. Overview of Processing in Information Collection System 1000>

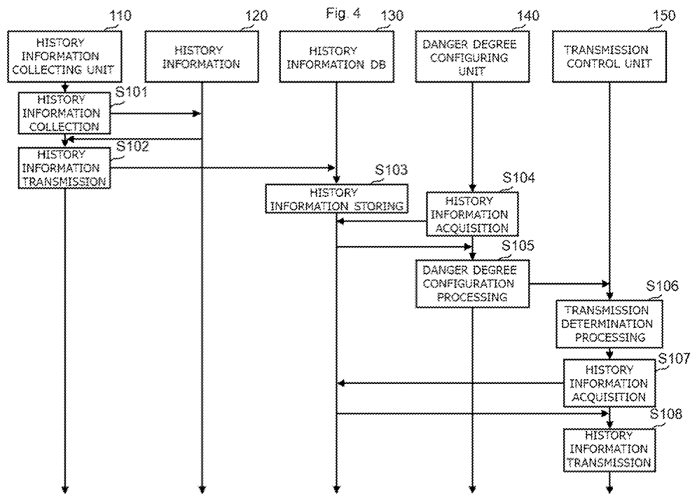

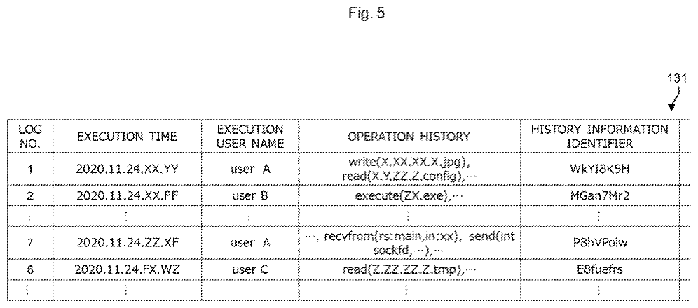

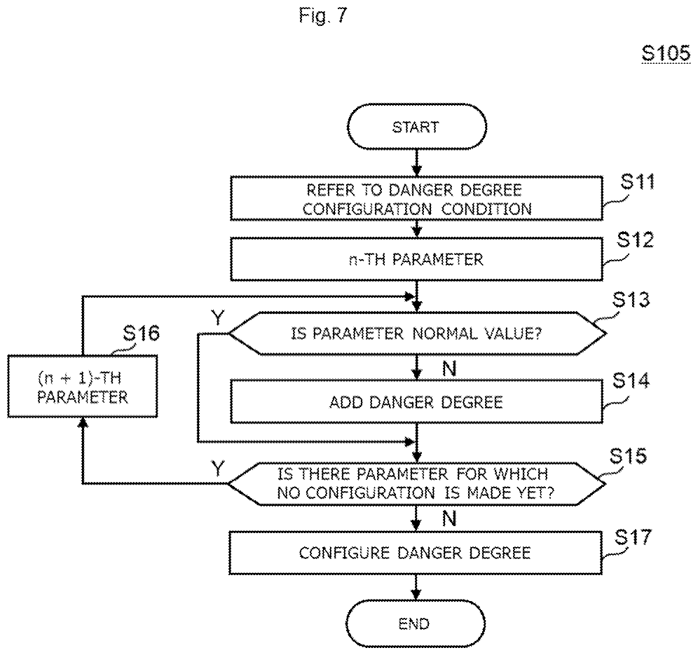

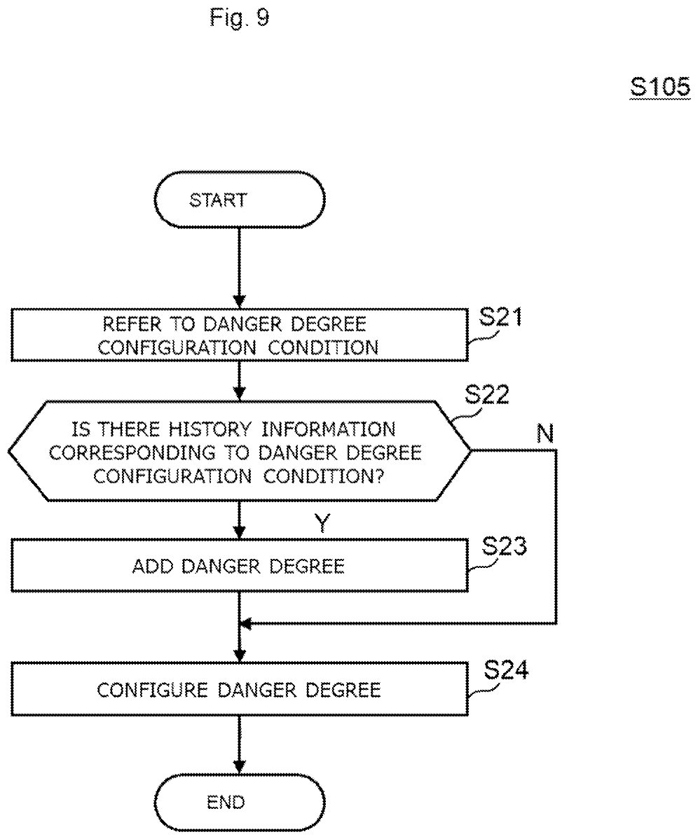

Next, with reference to FIGS. 4 to 11, an overview of processing in the information collection system 1000 of the present example embodiment will be described. FIG. 4 is a sequence diagram illustrating a flow of processing in the information collection system 1000. FIG. 5 is a diagram illustrating a configuration of a history information data table 131. FIG. 6 is a diagram illustrating an example of information described in the danger degree configuration condition 161. FIG. 7 is a flowchart illustrating an example of a flow of the danger degree configuration processing in the device 1. FIG. 8 is a diagram illustrating an example of information described in the danger degree configuration condition 162. FIG. 9 is a flowchart illustrating another example of the flow of the danger degree configuration processing in the device 1. FIG. 10 is a diagram illustrating a configuration of the danger degree information configured in the danger degree configuration processing. FIG. 11 is a flowchart illustrating a flow of the transmission determination processing in the device 1.

### <2.3.1. Flow of Processing in Information Collection System 1000>

First, with reference to FIG. 4, a flow of processing in the information collection system 1000 will be described. In FIG. 4, the device 1 (history information collecting unit 110) executes collection processing for collecting the history information 120 in step S101. In the present example, the collection processing by the history information collecting unit 110 may be continuously performed while the device 1 is in operation, for example. The history information 120 being a collection target in the collection processing may be configured in advance, and the history information 120 configured as a collection target may be collected. Further, a timing when the history information collecting unit 110 performs the collection processing may be configured in advance.

In step S102, the device 1 (history information collecting unit 110) transmits the history information 120 collected in the collection processing (step S101), to the history information DB 130.

In the collection processing, the history information collecting unit 110 collects, as the history information 120, information related to the name of a system call or a library function invoked by the program operating with the device 1. In addition to such information, in the collection processing, the history information collecting unit 110 collects, as the history information 120, at least one of information related to the execution time of the system call or the library function, information related to a user of the program operating with the device 1, information related to a file accessed by the program operating with the device 1, and the like, for example.

In the present example embodiment, assume that the history information collecting unit 110 collects, as the history information 120A, information including “execution time: 2020.11.24.XX.YY”, “execution user name: user A”, and “history information: write(X.XX.XX.X.jpg), read(X.Y.ZZ.Z.config), . . . ”.

In the present example embodiment, also assume that the history information collecting unit 110 collects, as the history information 120B, information including “execution time: 2020.11.24.XX.FF”, “execution user name: user B”, and “history information: execute(ZX.exe), . . . ”.

In the present example embodiment, also assume that the history information collecting unit 110 collects, as the history information 120C, information including “execution time: 2020.11.24.ZZ.XF”, “execution user name: user A”, and “history information: . . . , recvfrom(rs:main, in:xx), send(int sockfd, . . . ), . . . ”.

In the present example embodiment, further assume that the history information collecting unit 110 collects, as the history information 120D, information including “execution time: 2020.11.24.FX.WZ”, “execution user name: user C”, and “history information: read(Z.ZZ.ZZ.Z.tmp), . . . ”.

Next, in the device 1, the history information 120 transmitted from the history information collecting unit 110 in step S102 is stored in the history information DB 130 in step S103.

Here, with reference to FIG. 5, a configuration of the information stored in the history information DB 130 will be described. As illustrated in FIG. 5, in the present example embodiment, the pieces of history information 120A, 120B, 120C and 120D collected by the history information collecting unit 110 through the collection processing and history information identifiers for identifying the respective pieces of history information 120A, 120B, 120C, and 120D are stored in association with each other in the history information DB 130.

In FIG. 5, the information indicating {“execution time: 2020.11.24.XX.YY”, “execution user name: user A”, “history information: write(X.XX.XX.X.jpg, read(X.Y.ZZ.Z.config), . . . ”, and “history information identifier: WkYI8KSH”} is stored in the row indicated as No. 1 in the history information data table 151. In other words, the history information 120A collected by the history information collecting unit 110 is stored in the history information DB 130 in association with the “history information identifier: WkYI8KSH” identifying the history information 120A.

The information indicating {execution time: 2020.11.24.XX.FF”, “execution user name: user B”, “history information: execute(ZX.exe), . . . ”, and “history information identifier: MGan7Mr2”} is stored in the row indicated as No. 2 in the history information data table 151. In other words, the history information 120B collected by the history information collecting unit 110 is stored in the history information DB 130 in association with the “history information identifier: MGan7Mr2” identifying the history information 120B.

The information indicating {“execution time: 2020.11.24.ZZ.XF”, “execution user name: user A”, and “history information: . . . , recvfrom(rs:main, in:xx), send(int sockfd, . . . ), . . . ”, and “history information identifier: P8hVPoiw”} is stored in the row indicated as No. 7 in the history information data table 151. In other words, the history information 120C collected by the history information collecting unit 110 is stored in the history information DB 130 in association with the “history information identifier: P8hVPoiw” identifying the history information 120C.

The information indicating {“execution time: 2020.11.24.FX.WZ”, “execution user name: user C”, “history information: read(Z.ZZ.ZZ.Z.tmp), . . . ”, and “history information identifier: E8fuefrs”} is stored in the row indicated as No. 8 in the history information data table 151. In other words, the history information 120D collected by the history information collecting unit 110 is stored in the history information DB 130 in association with the “history information identifier: E8fuefrs” identifying the history information 120D.

In step S104, the danger degree configuring unit 140 acquires the history information 120 from the history information DB 130. When the danger degree configuring unit 140 acquires the history information 120, the danger degree configuring unit 140 executes the danger degree configuration processing in step S105. Details of the danger degree configuration processing will be described below with reference to FIGS. 6 to 10.

When danger degree is configured for the history information 120 by the danger degree configuring unit 140, the transmission control unit 150 executes the transmission determination processing in step S106. In the transmission determination processing, processing for determining whether it is a timing for transmitting the history information of the device 1 to the server 2, processing for determining whether to transmit the history information of the device 1 to the server 2, and the like. Details of the transmission determination processing will be described below with reference to FIGS. 10 and 11.

In step S107, the transmission control unit 150 acquires the history information 120 determined to be transmitted to the server 2 as a result of the transmission determination processing in step S106, from the history information DB 130. Then, the transmission control unit 150 transmits the history information 120 acquired in step S107 to the server 2 via the network I/F 101 in step S108.

In this way, in the device 1, processing for collecting the history information 120 of the program operating with the device 1 and controlling a timing for transmitting the collected history information 120 to the server 2 is performed.

### <2.3.2. Overview of Danger Degree Configuration Processing in Device 1>

Next, with reference to FIGS. 6 to 10, details of the danger degree configuration processing performed in step S105 in the device 1 will be described. The history information 120 includes, as a history of a system call or a library function, various parameters such as an execution date and time and execution user name. Hence, it is possible to determine the degree of security risk such as an indication of a cyberattack and vulnerability for the device 1, based on the values of the parameters included in the history information 120.

In a cyberattack for the device 1, a plurality of system calls and library functions are invoked, and information resources of the device 1 are used. Hence, if system calls included in an attack pattern and the order of execution of the system calls are known, it is possible to determine the degree of security risk such as an indication of a cyberattack and vulnerability for the device 1. Also for library functions, similarly to system calls, if library functions included in an attack pattern and the order of execution of the library functions are known, it is possible to determine the degree of security risk in the device 1. Note that, for a cyberattack combining system calls and library functions, if the system calls and the library functions included in an attack pattern and the order of execution of the system calls and the library functions are known, it is possible to determine the degree of security risk in the device 1.

In the present example embodiment, by using characteristics of system calls as those described above, the danger degree configuration processing for configuring danger degree for the history information 120 collected by the history information collecting unit 110 is performed. Here, first, a description will be given, after a description of details of the danger degree configuration processing based on the danger degree configuration condition 161 in which parameters are described, of details of the danger degree configuration processing based on the danger degree configuration condition 162 in which an attack pattern is described. In the following, for description, the danger degree configuration processing based on the danger degree configuration condition 161 in which parameters are described may be referred to as first processing, and the danger degree configuration processing based on the danger degree configuration condition 162 in which an attack pattern is described may be referred to as second processing, in some cases.

<2.3.2.1. Flow of Danger Degree Configuration Processing Based on Danger Degree Configuration Condition in which Parameters are Described>

As described above, a history of a system call or a library function includes various parameters such as an execution date and time and an execution user name. The danger degree configuring unit 140 executes the first processing (refer to FIG. 7), based on the danger degree configuration condition 161 (refer to FIG. 6) in which information defining a normal value and an abnormal value for each of these parameters is described.

In the first processing, first, based on the history information 120, the degree of security risk in the device 1 is determined based on the user, execution time, and the like of the program that has executed a system call or a library function. Next, danger degree is configured for the history information 120, based on the result of the determination. The first processing corresponds to processing for configuring, for each parameter of a particular system call (or library function), danger degree depending on whether the parameter indicating an abnormal value is included in the history information 120.

In the danger degree configuration condition 161 illustrated in FIG. 6, information indicating the first parameter “user name”, the second parameter “execution time”, and the like for “system call name: execve” is included.

For the first parameter “user name” in the danger degree configuration condition 161, information configuring “danger degree: 0” when information of an execution user name of a system call execve included in the history information 120 is information corresponding to “user name: user A” and configuring “danger degree: 10” when the information of the execution user name is information corresponding to “user name: other than user A” is described. In other words, for the first parameter “user name” in the danger degree configuration condition 161, information configuring “danger degree: 0” when the information of the execution user name of the system call execve included in the history information 120 is information corresponding to “user name: user A”, which is a normal value, and configuring, as danger degree, “danger degree: 10”, which is the value indicating that there is a security risk for the device 1, when the information of the execution user name is information corresponding to “user name: other than user A”, which is an abnormal value, is described.

For the second parameter “execution time” in the danger degree configuration condition 161, information configuring “danger degree: 0” when the information of the execution time of the system call execve included in the history information 120 is information corresponding to “execution time: between 14:00 and 18:00” and configuring “danger degree: 20” when the information of the execution time is information corresponding to “execution time: time period other than 14:00 to 18:00” is described. In other words, for the second parameter “execution time” in the danger degree configuration condition 161, information configuring “danger degree: 0” when the information of the execution time of the system call execve included in the history information 120 is information corresponding to “execution time: between 14:00 and 18:00”, which is a normal value, and configuring, as danger degree, “danger degree: 20”, which is the value indicating that there is a security risk for the device 1, when the information of the execution time is information corresponding to “execution time: other than 14:00 to 18:00”, which is an abnormal value, is described.

When the danger degree configuring unit 140 acquires the history information 120 (step S104, refer to FIG. 4), the danger degree configuring unit 140 refers to the danger degree configuration condition 161 in step S11. The danger degree configuration condition 161 is configured values stored in the danger degree configuring unit 140 and can be configured based on information transmitted from the server 2 by an operator of the information collection system 1000 operating the server 2, for example. The danger degree configuration condition 161 may be configured values stored in the danger degree configuring unit 140 at the time of product shipping of the device 1.

In step S12, the danger degree configuring unit 140 focuses on an n-th parameter in the danger degree configuration condition 161 referred to in step S11. The danger degree configuring unit 140 sequentially focuses on n parameters included in the danger degree configuration condition 161 from the first parameter. Here, the description will be continued by assuming that n=2, in other words, the second parameter in the danger degree configuration condition 161, is focused.

In step S13, the danger degree configuring unit 140 compares each of the pieces of history information 120A to 120D and the second parameter in the danger degree configuration condition 161, to determine whether the value in each of the pieces of history information 120A to 120D corresponding to the second parameter in the danger degree configuration condition 161 is a normal value. “System call: execve” is not included in the pieces of history information 120A, 120C, and 120D. In the following description of the first processing, a description will be given by taking the history information 120B as an example.

In the history information 120B, it is described that the time at which “system call: execve” is executed is “2020.11.24.XX.FF”. When the execution time “XX.FF” of “system call: execve” is “between 14:00 and 18:00” in the history information 120B, the danger degree configuring unit 140 configures “danger degree: 0” for the history information 120B and advances to step S15. In contrast, when the execution time “XX.FF” of “system call: execve” is “time period other than between 14:00 and 18:00” in the history information 120B, the danger degree configuring unit 140 adds “danger degree: 10” to the history information 120B in step S14 and advances to step S15. Note that “System call: execve” is not included in the pieces of history information 120A, 120C, and 120D, and hence, the danger degree configuring unit 140 configures “danger degree: 0” for the pieces of history information 120A, 120C, and 120D.

Note that, when the danger degree configuration condition 161 focuses on the first parameter in step S12, the user who has executed “system call: execve” is “user B” in the history information 120B. In this case, for the history information 120B, “danger degree: 10” indicating that there is a security risk for the device 1 is configured for the first parameter “user name” in the danger degree configuration condition 161.

In step S15, the danger degree configuring unit 140 determines whether there is a parameter for which no danger degree is configured, related to the parameters included in the danger degree configuration condition 161, in the history information 120B. When there is a parameter for which no danger degree is configured in the history information 120B (step S15/N), the danger degree configuring unit 140 focuses on the (n+1)-th parameter in step S16 and executes the processing from step S13 again.

When danger degree is configured for each of all the parameters included in the danger degree configuration condition 161 for the history information 120B (step S15/Y), the danger degree configuring unit 140 adds up the configured danger degrees related to the parameters included in the history information 120B and configures danger degree for the history information 120B, in step S17. In other words, when the execution time “XX.FF” of “system call: execve” is “between 14:00 and 18:00” in the history information 120B, the danger degree of the history information 120B is configured at “10” as a result of step S17. In contrast, when the execution time “XX.FF” of “system call: execve” is “time period other than between 14:00 and 18:00” in the history information 120B, the danger degree of the history information 120B is configured at “30”.

As illustrated in the row indicated as No. 2 in FIG. 10, the danger degree configured by the danger degree configuring unit 140 is stored in the danger degree information data table 163 in the danger degree configuration DB 160 in association with the history information identifier “MGan7Mr2” for identifying the history information 120B and “danger degree: 10 or 30”.

As described above, in the first processing, the degree of security risk in the device 1 is determined based on the user, execution time, and the like of execution of a system call, and danger degree is configured for the history information 120, based on the result of the determination. The first processing corresponds to processing for configuring, for each parameter of an operation history of a particular system call, danger degree depending on whether the parameter indicating an abnormal value is included in the history information 120.

<2.3.2.2. Flow of Danger Degree Configuration Processing Based on Danger Degree Configuration Condition in which Attack Pattern is Described>

As described above, a plurality of system calls are invoked by the program operating with the device 1. The danger degree configuring unit 140 executes the second processing (refer to FIG. 9), based on the danger degree configuration condition 162 (refer to FIG. 8) in which a known attack pattern or an attack pattern configured in advance based on an index of a vulnerability evaluation related to the device 1 and the like is described.

In the second processing, first, based on the history information 120, the degree of security risk in the device 1 is determined based on a system call and/or a library function particular to the attack pattern and the execution order of system calls and/or library functions. Next, danger degree is configured for the history information 120, based on the result of the determination. The second processing corresponds to processing for configuring danger degree depending on whether information corresponding to the system call and/or library function particular to the attack pattern and the execution order of the system calls and/or library functions are included in the history information 120. The information corresponding to the system call and/or library function particular to the attack pattern and the execution order of the system calls and/or library functions corresponds to attack related information related to the attack pattern.

The danger degree configuration condition 162 illustrated in FIG. 8 includes information indicating “system call SC1 (normal); danger degree: 0”, “recvfrom(rs:main, in:xx) (normal); danger degree: 0”, “send(int sockfd, . . . ) (normal) (danger degree: 100)”.

In the danger degree configuration condition 162, a plurality of system calls and/or library functions, the execution order of the system calls and/or library functions are described. Among these, information configuring “danger degree: 100” for an execution history of the system call “send(int sockfd, . . . ) (normal)” is described. In this way, when an operation including a known attack pattern or an attack pattern configured in advance based on an index of a vulnerability evaluation or the like related to the device 1 is performed in the device 1, danger degree is configured by the danger degree configuring unit 140.

When the pieces of history information 120A, 120B, 120C, and 120D are acquired (step S104, refer to FIG. 4), the danger degree configuring unit 140 refers to the danger degree configuration condition 162 in step S21. The danger degree configuration condition 162 is configured values stored in the danger degree configuring unit 140 and can be configured based on information transmitted from the server 2 by an operator of the information collection system 1000 operating the server 2, for example. The danger degree configuration condition 162 may be configured values stored in the danger degree configuring unit 140 at the time of product shipping of the device 1.

In step S22, the danger degree configuring unit 140 determines whether the history information 120 acquired in step S104 includes history information 120 corresponding to the information described in the danger degree configuration condition 162 referred to in step S21. Among the pieces of history information 120A, 120B, 120C, and 120D, the history information 120C is information including “history information: . . . , recvfrom(rs:main, in:xx), send(int sockfd, . . . ), . . . ” and is hence determined as the information corresponding to “system call SC1”, “recvfrom(rs:main, in:xx)”, and “send(int sockfd, . . . )” described in the danger degree configuration condition 162 (step S22/Y). The danger degree configuring unit 140 adds “danger degree: 100” for the history information 120C in step S23 and advances to step S24.

In contrast, in step S22, the pieces of history information 120A, 120B, and 120D are not determined as the history information corresponding to the information described in the danger degree configuration condition 162 (step S22/N). In this case, the danger degree configuring unit 140 advances to step S24.

In step S24, the danger degree configuring unit 140 configures “danger degree: 0” for the history information 120A, “danger degree: 0” for the history information 120B, “danger degree: 100” for the history information 120C, and “danger degree: 0” for the history information 120D.

As illustrated in the row indicated as No. 7 in FIG. 10, the danger degree configured for the history information 120C by the danger degree configuring unit 140 is stored in the danger degree information data table 163 in the danger degree configuration DB 160 in a manner in which the history information identifier “P8hVPoiw” for identifying the history information 120C and “danger degree: 100” are associated with each other. Note that the danger degree configured for the history information 120B in the first processing is illustrated in the row indicated as No. 2 in FIG. 10.

As described above, in the second processing, the degree of security risk in the device 1 is determined based on a system call and/or a library function particular to an attack pattern and the execution order of system calls and/or library functions, and danger degree is configured for the history information 120, based on the result of the determination. The second processing corresponds to processing for configuring danger degree depending on whether information corresponding to the system call and/or library function particular to the attack pattern and the execution order of the system calls and/or library functions are included in the history information 120.

### <2.3.3. Flow of Transmission Determination Processing in Device 1>

Next, with reference to FIGS. 10 and 11, details of the transmission determination processing in the device 1 will be described. Assume that, as a result of the danger degree configuration processing by the danger degree configuring unit 140, “danger degree: 10 or 30” is configured for the history information 120B and “danger degree: 100” is configured for the history information 120C (refer to FIG. 10).

In step S31, the transmission control unit 150 acquires, as the danger degree information stored in the danger degree information data table 163, information indicating that “danger degree: 10 or 30” is configured for the history information 120B and information indicating that “danger degree: 100” is configured for the history information 120C.

In step S32, the transmission control unit 150 transmits the history information 120 configured with a first value or greater as danger degree, to the server 2. For example, when “danger degree: 10” is configured as the first value, the transmission control unit 150 acquires information with “danger degree: 10” or greater from the danger degree information data table 163. As a result of the first processing and the second processing, information with “danger degree: 10” or greater is stored in No. 2 and No. 7 in the danger degree information data table 163 illustrated in FIG. 10. The transmission control unit 150 acquires the history information identifiers “MGan7Mr2” and “P8hVPoiw” in the rows of No. 2 and No. 7. Next, the transmission control unit 150 transmits the history information 120B and the history information 120C identified based on the history information identifiers “MGan7Mr2” and “P8hVPoiw” in the history information data table 151, to the server 2 via the network T/F 101.

In step S33, when the total of the danger degrees of all the pieces of history information 120 is a second value or greater, the transmission control unit 150 transmits the history information 120 to the server 2. For example, when “danger degree: 40” is configured as the second value, the total of the danger degrees of all the pieces of history information 120 is “danger degree: 100+10 (or +30)” as a result of the first processing and the second processing. In this case, the transmission control unit 150 transmits the pieces of history information 120A, 120B, 120C, and 120D to the server 2 via the network I/F 101.

In step S34, the transmission control unit 150 transmits the history information 120 including a particular system call to the server 2. The particular system call corresponds, for example, to a system call invoked by the device 1 when an operation not preferable from the viewpoint of security is performed. The operation not preferable from the viewpoint of security corresponds, for example, to access to an important file system of the device 1, such as a system folder and access to a registry related to automatic execution of a program and the like.

In step S35, the transmission control unit 150 transmits the history information 120 related to an operation history of an operation executed within a predetermined time period in the device 1, to the server 2. Assume that the operation time period of the device 1 is configured from 5:00 to 23:00. In this case, the transmission control unit 150 may transmit the history information 120 related to operations observed in the device 1 between 23:00 and 5:00, to the server 2.

In step S36, when the amount of the history information 120 collected by the history information collecting unit 110 reaches a predetermined amount or larger, the transmission control unit 150 transmits the history information 120 to the server 2. Here, a state where the amount of the history information 120 reaches the predetermined amount or larger corresponds, for example, to a case where the history information 120 reaches a predetermined number of bytes or more, a case where the number of rows of the history information 120 stored in the history information DB 130 reaches a predetermined number of rows or more, and the like.

In step S37, when a predetermined time period is elapsed from the last transmission of history information to the server 2, the transmission control unit 150 transmits the history information 120 to the server 2. For example, when 12 hours is elapsed from the last transmission of history information to the server 2, the transmission control unit 150 transmits the history information 120 collected in the device 1 after the last transmission of the history information, to the server 2.

Note that the transmission control unit 150 may perform any one of the processes in steps S32 to S37.

In this way, in the present example embodiment, processing for selecting the history information 120 to transmit and processing for controlling a timing for transmitting the history information 120 are performed in the device 1. With this, it is possible to reduce, in the server 2, processing load when analyzing a security risk for the device 1, based on history information of the device 1.

### 3. Example Alteration of First Example Embodiment

Next, as an example alteration of the first example embodiment, a configuration of separating an OS execution environment of the device 1 and an environment in which control of transmission of the history information 120 of the device 1 is performed, in order to improve reliability of information related to operation of equipment will be described.

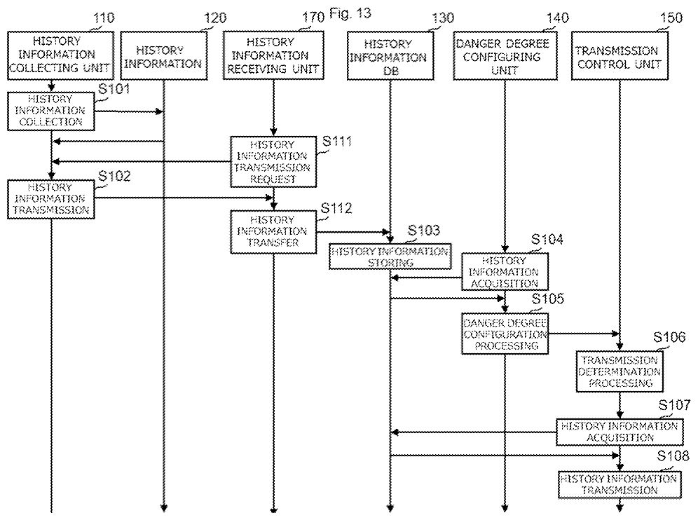

In the present example alteration, the same configuration is denoted by the same reference sign as that in the first example embodiment, and overlapping descriptions may be omitted. Unless otherwise specifically noted, since the operation of the device 1 in the present example alteration is the same as that in the first example embodiment, steps for performing equivalent processing as that in the first example embodiment are denoted by the same reference signs to those in the first example embodiment in FIG. 13, and overlapping descriptions are omitted.

### <3.1. Functional Configuration of Device 1>

First, with reference to FIG. 12, a functional configuration of the device 1 according to the present example alteration will be described. FIG. 12 is a functional block diagram illustrating a functional configuration of the device 1 according to the example alteration of the first example embodiment. The device 1 includes a normal region 102 including the history information collecting unit 110, and a protected region 103 including the history information DB 130, the danger degree configuring unit 140, the transmission control unit 150, the danger degree configuration DB 160, and a history information receiving unit 170.

The normal region 102 of the device 1 indicates a normal execution environment which is constructed in a memory (ROM 12 and RAM 13) space of the device 1 and in which the OS and the like of the device 1 are executed.

The protected region 103 of the device 1 indicates a secure space (Secure World) which is more secure than the normal region 102 and is constructed separately from the normal region 102 in the memory (ROM 12 and RAM 13) space of the device 1 by a technique such as TrustZone (registered trademark) by Arm Limited or KeyStone by RISC-V International. By locating secret information and implementing security processing in the protected region 103 constructed in the device 1, leak of the secret information and manipulation of various kinds of processing performed in the device 1 can be prevented.

In addition, the protected region 103, which is a secure space, cannot be directly accessed from the normal region 102, which is a non-secure space. Hence, in the present example alteration, the history information receiving unit 170 as an element configured to receive the history information 120 collected in the normal region 102, in the protected region 103 is provided in the protected region 103.

### <3.2. Flow of Processing in Information Collection System 1000>

Next, with reference to FIG. 13, a flow of processing in the information collection system 1000 according to the example alteration of the first example embodiment will be described. The present example alteration is different from the first example embodiment in that the present example alteration includes processing in which the history information receiving unit 170 requests to transmit the history information 120 to the protected region 103.

In step S11, the history information receiving unit 170 performs, on the history information collecting unit 110, a history information transmission request for requesting to transmit the history information 120 to the protected region 103. When the history information collecting unit 110 receives the history information transmission request, the history information collecting unit 110 transmits the history information 120 to the history information receiving unit 170 in step S102.

When the history information collecting unit 110 transmits the history information 120, the history information receiving unit 170 transfers the history information 120 transmitted from the history information collecting unit 110, to the history information DB 130 in step S112. As in the first example embodiment, the pieces of history information 120A, 120B, 120C and 120D collected by the history information collecting unit 110 through the collection processing and history information identifiers for identifying the respective pieces of history information 120A, 120B, 120C, and 120D are stored in the history information DB 130 in association with each other. The processing subsequent to step S112 is the same as that in the first example embodiment.

In this way, in the present example alteration, processing for selecting the history information 120 to transmit and processing for controlling a timing for transmitting the history information 120 are performed in the protected region 103, which is more secure than the normal region 102 where the OS of the device 1 is executed, in a state of being separated from the normal region 102. With the above configuration, it is possible to reduce manipulation of the collected history information 120, damage of data, and the like and is hence possible to transmit history information of the device 1 to the server 2 with improved reliability of information related to operation of equipment.

### 4. Second Example Embodiment

A second example embodiment is different from the first example embodiment in that the history information collecting unit 110 optimizes an operation history of the device 1 being a collection target of collection processing.

In the present example embodiment, the same configuration is denoted by the same reference sign as that in the first example embodiment, and overlapping descriptions may be omitted. Unless otherwise specifically noted, since the operation of the device 1 in the present example embodiment is the same as that in the first example embodiment, overlapping descriptions are omitted.

### <4.1. Functional Configuration of Device 1>

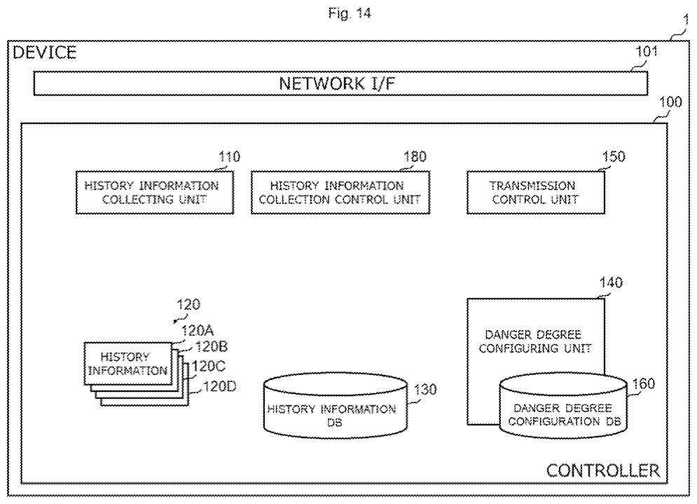

First, with reference to FIG. 14, a functional configuration of a device 1 according to the second example embodiment will be described. FIG. 14 is a functional block diagram illustrating a functional configuration of the device 1 according to the second example embodiment. The device 1 includes the history information collecting unit 110, the history information DB 130, the danger degree configuring unit 140, the transmission control unit 150, the danger degree configuration DB 160, and a history information collection control unit 180.

The history information collection control unit 180 executes collection target optimization processing for optimizing an operation history of a program operating with the device 1 being a collection target of the collection processing by the history information collecting unit 110.

### <4.2. Flow of Collection Target Optimization Processing in Device 1>

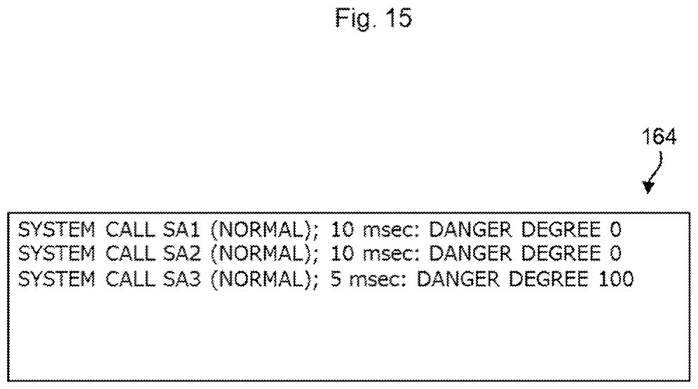

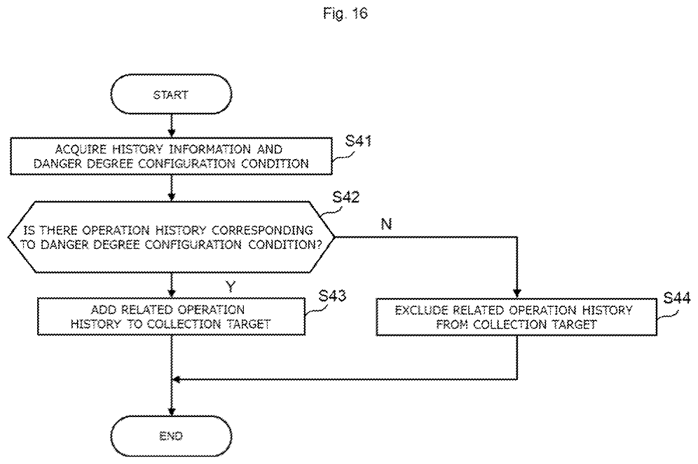

Next, with reference to FIGS. 15 and 16, a flow of the collection target optimization processing will be described. FIG. 15 is a diagram illustrating an example of information described in the danger degree configuration condition 164. FIG. 16 is a flowchart illustrating a flow of the collection target optimization processing in the device 1.

In a cybrattack for the device 1, a plurality of system calls are invoked, and information resources of the device 1 are used. In the present example embodiment, it is assumed that a history information for which a security risk such as an indication of a cyberattack for the device 1 is assumed based on system calls included in an attack pattern, the order of system calls, and execution histories of system calls, is a collection target.

The danger degree configuration condition 164 illustrated in FIG. 15 includes information indicating “system call SA1 (normal); 10 msec: danger degree: 0”, “system call SA2 (normal); 10 msec: danger degree: 0”, and “system call SA3 (normal); 5 msec: danger degree: 100”. In the danger degree configuration condition 164 in FIG. 15, operations including an attack pattern in which the system call SA1, the system call SA2, and the system call SA3 are sequentially performed are described. In other words, the danger degree configuration condition 164 corresponds to information including an operation history indicating that there is a security risk for the device 1.

In the danger degree configuration condition 164, information configuring “danger degree: 100” for operation histories of the device 1 in which the system call SA1 is performed normally within 10 msec, the system call SA2 is performed normally within 10 msec, and the system call SA3 is performed normally within 5 msec is described.

Next, with reference to FIG. 16, a flow of the collection target optimization processing executed in the device 1 will be described. In the description of FIG. 16, a description will be given by assuming that an operation history of the device 1 being a collection target of the collection processing by the history information collecting unit 110 is referred to as a “collection target operation history”.

In step S41, the history information collection control unit 180 acquires the history information 120 collected by the history information collecting unit 110 and the danger degree configuration condition 164. Next, in step S42, the history information collection control unit 180 determines whether the history information 120 acquired in step S41 includes an operation history corresponding to the danger degree configuration condition 164.

When the history information 120 collected by the history information collecting unit 110 includes an operation history of the device 1 corresponding to the danger degree configuration condition 164 (step S42/Y), the history information collection control unit 180 adds the operation history of the device 1 related to the collection target operation history, to the collection target in step S43.

Here, assume that, in the device 1 for which the system call SA1 is configured as a collection target operation history, the system call SA1 is performed within 10 msec. In this case, the history information collection control unit 180 adds, to the collection target in step S43, the system calls SA2 and SA3 described in the danger degree configuration condition 164 as related operation histories related to the system call SA1 as the collection target operation history. Then, the history information collecting unit 110 executes the collection processing with the system calls SA1, SA2, and SA3 as collection targets. In other words, in this case, the operation history indicating that there is a security risk for the device 1 is added to the collection target operation history.

When the history information 120 collected by the history information collecting unit 110 does not include any operation history of the device 1 corresponding to the danger degree configuration condition 164 (step S42/N), the history information collection control unit 180 exclude the operation histories of the device 1 related to the collection target operation histories, from the collection target in step S44.

Here, a description will be given by taking, as an example, the device 1 for which operation histories of a case where the system call SA1 is performed normally within 10 msec, the system call SA2 is performed normally within 10 msec, and the system call SA3 is performed normally within 5 msec, are configured as collection target operation histories. In this case, the collection target operation histories configured for the device 1 correspond to information described in the danger degree configuration condition 164. In other words, the collection target operation histories configured for the device 1 here include an operation history indicating that there is a security risk for the device 1.

Assume, in such a case, that the history information 120 indicating that the system calls SA1, SA2, and SA3 are sequentially performed and execution of the system call SA2 has taken 10 msec or more is collected. In this case, the history information collection control unit 180 determines that the operation histories where the system calls SA1, SA2, and SA3 are sequentially performed are those not related to the collection target operation histories, and excludes the system call SA2 and the system call SA3 from the collection target operation histories in step S44. The history information collecting unit 110 excludes the system calls SA2 and SA3 from the collection targets and executes the collection processing.

As described above, in the present example embodiment, the collection target optimization processing is performed based on history information collected by the history information collecting unit 110. In the above configuration, history information collected in the device 1 is optimized according to operation of a program operating with the device 1, and hence, history information transmitted to the server 2 is also optimized.

In the collection target optimization processing, an operation history related to a pattern of attacking the device 1 is added to a collection target while an operation history no longer related to the pattern of attacking the device 1 is excluded from the collection target. According to the above configuration, it is possible to selectively transmit, to the server 2, history information expected that there is a security risk for the device 1, and is hence possible to reduce processing load of the server 2.

### 5. Example Alteration of Second Example Embodiment

Next, as an example alteration of the second example embodiment, a configuration of separating an OS execution environment of the device 1 and an environment in which control of transmission of the history information 120 of the device 1 is performed, in order to improve reliability of information related to operation of equipment will be described.

In the present example alteration, the same configuration is denoted by the same reference sign as that in the second example embodiment, and overlapping descriptions may be omitted. Unless otherwise specifically noted, since the operation of the device 1 in the present example alteration is the same as that in the second example embodiment, overlapping descriptions are omitted.

### <5.1. Functional Configuration of Device 1>

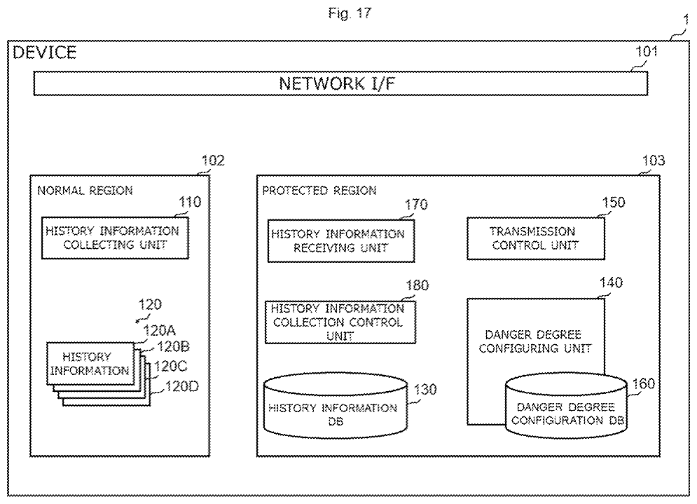

First, with reference to FIG. 17, a functional configuration of the device 1 according to the present example alteration will be described. FIG. 17 is a functional block diagram illustrating a functional configuration of the device 1 according to the example alteration of the second example embodiment. The device 1 includes the normal region 102 including the history information collecting unit 110, and the protected region 103 including the history information DB 130, the danger degree configuring unit 140, the transmission control unit 150, the danger degree configuration DB 160, the history information receiving unit 170, and the history information collection control unit 180.

In the present example alteration, collection target optimization processing for optimizing an operation history collected by the history information collecting unit 110 is performed in the protected region 103, which is more secure than the normal region 102, in which the OS of the device 1 is executed, in a state of being separated from the normal region 102. In this way, it is possible to reduce manipulation of the collected history information 120, damage of data, and the like and is hence possible to optimize an operation history collected by the history information collecting unit 110 with improved reliability of information related to operation of equipment and transmit history information of the device 1 to the server 2.

### 6. Third Example Embodiment

A third example embodiment is different from the first and second example embodiments in that the history information collecting unit 110 optimizes an operation history of the device 1 being a collection target of the collection processing, based on an indication by the server 2.

In the present example embodiment, overlapping descriptions of the same configuration as that in the first example embodiment are omitted. Unless otherwise specifically noted, since the functional configuration and the operation of the device 1 in the present example embodiment are the same as those in the first example embodiment, overlapping descriptions are omitted.

### <6.1. Functional Configuration of Server 2>

First, with reference to FIG. 18, a functional configuration of a server 2 according to the third example alteration will be described. FIG. 18 is a functional block diagram illustrating a functional configuration of the server 2 according to the third example embodiment. As illustrated in FIG. 18, the server 2 includes a controller 200 and a network I/F 201.

The controller 200 is configured to receive history information transmitted from the device 1 and execute processing for analyzing a security risk for the device 1, collection target optimization processing for optimizing an operation history being a collection target in the device 1, and the like. The controller 200 is configured by a dedicated software program being installed in the device 1. The controller 200 includes a history information receiving unit 210, a history information data base (DB) 220, a history information analyzing unit 230, and a history information collection control unit 240.

The history information receiving unit 210 is configured to receive the history information 120 transmitted from the device 1 and store the history information 120 in the history information DB 220, which is a storage region.

The history information analyzing unit 230 executes analysis processing for analyzing the degree of security risk in the device 1, based on the history information 120 received from the device 1.

The history information collection control unit 240 executes collection target optimization processing for optimizing an operation history of the device 1 being a collection target of the collection processing by the history information collecting unit 110, based on the history information 120 received from the device 1.

### <6.2. Flow of Collection Target Optimization Processing in Server 2>

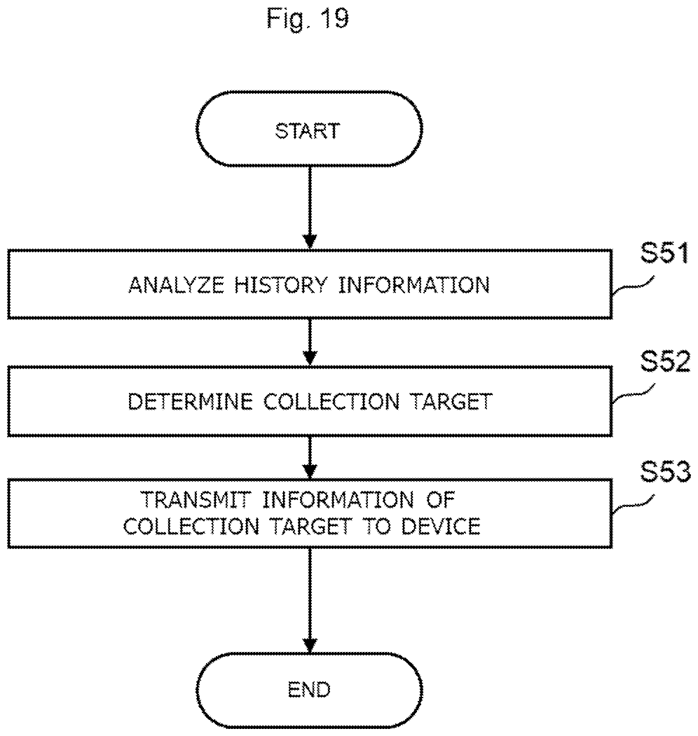

Next, with reference to FIG. 19, a flow of the collection target optimization processing in the server 2 will be described. FIG. 19 is a flowchart illustrating a flow of the collection target optimization processing performed in the server 2 according to the third example embodiment.

In the collection target optimization processing in the server 2, first, the history information analyzing unit 230 performs analysis processing of the history information 120 received from the device 1 in step S51. The history information analyzing unit 230 performs security risk analysis related to the history information 120 received from the device 1, based on a known vulnerability evaluation criterion such as the Common Vulnerability Scoring System (CVSS).

Next, in step S52, the history information collection control unit 240 determines an operation history to be a collection target of the collection processing by the history information collecting unit 110, based on the history information 120 received from the device 1 and the result of the analysis processing. Note that the history information collection control unit 240 of the server 2 may determine an operation history to be a collection target of the collection processing by the history information collecting unit 110 by performing similar processing (refer to FIG. 16) as that by the history information collection control unit 180 of the device 1.

Next, in step S53, the history information collection control unit 240 transmits, to the device 1, information of an operation history to be a collection target of the collection processing by the history information collecting unit 110 determined in step S52. The history information collecting unit 110 of the device 1 executes the collection processing by including, in the collection target, the operation history determined as a collection target in step S52, based on the received information received from the server 2.

In the present example embodiment, the collection target optimization processing is performed in the server 2, based on history information collected by the history information collecting unit 110. Since the analysis processing for analyzing the degree of security risk in the device 1 is executed based on the history information in the server 2, it is possible to execute the collection processing with use of a result of the analysis processing. By executing the collection target optimization processing in the server 2, it is possible to reduce the processing load of the device 1.

Note that information input to the server 2 by an operation of the server 2 by an operator of the information collection system 1000 may be reflected in the collection target optimization processing in the server 2. Here, the information input to the server 2 corresponds to information specifying an operation history to be a collection target of the collection processing by the history information collecting unit 110, such as information specifying, as a collection target, the history information 120 related to an operation history of an operation performed within a predetermined time period in the device 1 or information specifying, as a collection target, the history information 120 including a particular system call.

### 7. Example Alteration of Third Example Embodiment

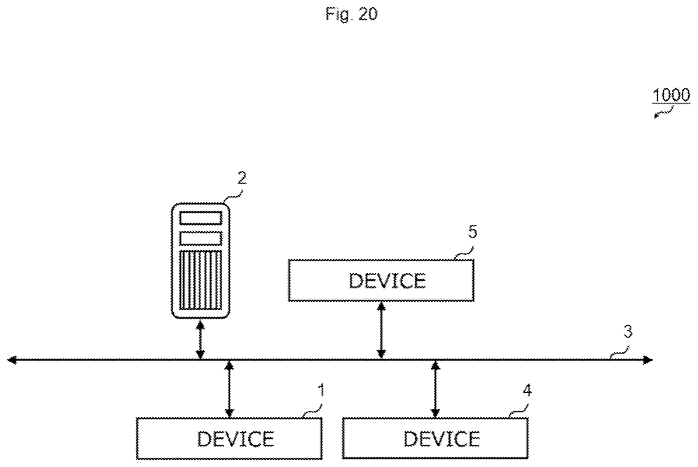

Next, as an example alteration of the third example embodiment, an information collection system 1000 in which devices 1, 4, and 5 are connected to the server 2 will be described. FIG. 20 is a diagram illustrating an operation mode of the information collection system 1000 according to the example alteration of the third example embodiment. In the information collection system 1000 according to the present example alteration, the device 1 and the devices 4 and 5, which are devices of the same model as that of the device 1, and the server 2 are connected to each other via the network 3.

In the present example alteration, the same configuration is denoted by the same reference sign as that in the first to third example embodiments, and overlapping descriptions may be omitted. Unless otherwise specifically noted, since the operation of the device 1 in the present example alteration is the same as that in the first example embodiment, overlapping descriptions are omitted.

In the present example alteration, the server 2 receives history information related to an operation history of each of programs operating with the devices 1, 4, and 5. Hence, the server 2 can execute the collection target optimization processing on the device 1, based on history information received from the device 4, for example. In other words, in the present example alteration, the collection target optimization processing in which history information acquired for each of the devices 1, 4, and 5 is used can be executed.

### 8. Fourth Example Embodiment

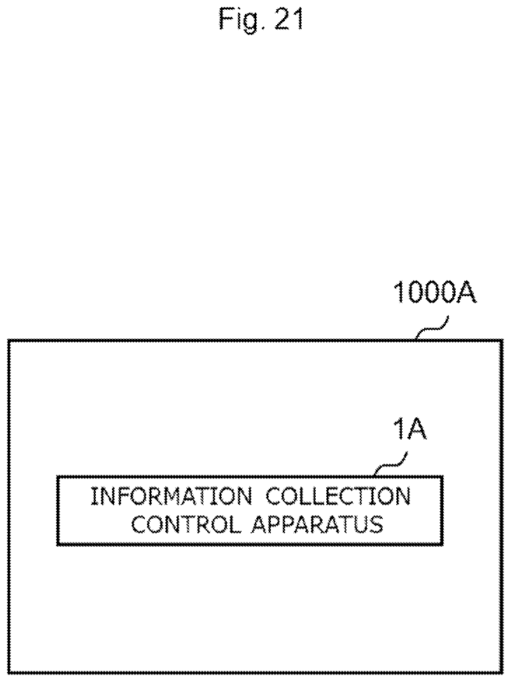

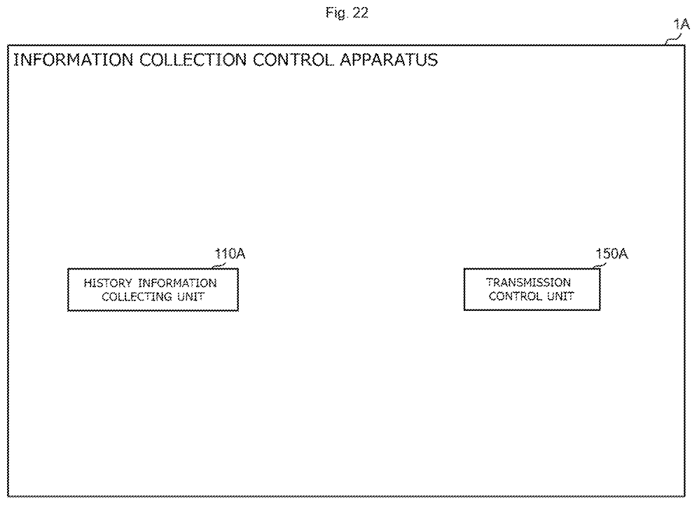

Next, with reference to FIGS. 21 and 22, a fourth example embodiment of the present invention will be described. The above-described first to third example embodiments are concrete example embodiments, whereas the fourth example embodiment is a more generalized example embodiment. According to the fourth example embodiment below, similar technical effects to those of the first to third example embodiments are exerted.

FIG. 21 is a block diagram illustrating a schematic configuration of an information collection system 1000A according to the fourth example embodiment of the present invention. As illustrated in FIG. 21, the information collection system 1000A includes an information collection control apparatus 1A.

FIG. 22 is a block diagram illustrating a schematic configuration of the information collection control apparatus 1A according to the fourth example embodiment. The information collection control apparatus 1A includes a history information collecting unit 110A and a transmission control unit 150A. The history information collecting unit 110 executes collection processing for collecting history information related to an operation history of a program operating with a terminal. The transmission control unit 150A controls a timing for transmitting the history information to a server.

### Relationship with First to Third Example Embodiments

As an example, the information collection control apparatus 1A according to the fourth example embodiment may perform operation of the device 1 according to any one of the first to third example embodiments. Similarly, as an example, the information collection system 1000A according to the fourth example embodiment may be configured similarly to the information collection system 1000 according to any one of the first to third example embodiments. In the above case, the descriptions of the first to third example embodiments may also be applicable to the fourth example embodiment. Note that the fourth example embodiment is not limited to the above example.

### 9. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram or flowchart. For example, the steps in the processing may be executed in an order different from that described in the corresponding sequence diagram or flowchart or may be executed in parallel. Some of the steps in the processing may be deleted, or more steps may be added to the processing.

An apparatus including constituent elements (for example, elements corresponding to the history information collecting unit 110 and the transmission control unit 150) of the device 1 described in the Specification may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### (Supplementary Note 1)

An information collection control apparatus comprising:
a history information collecting unit configured to perform collection processing for collecting history information related to an operation history of a program operating with a terminal; and
a transmission control unit configured to control a timing for transmitting the history information to a server.

### (Supplementary Note 2)

The information collection control apparatus according to supplementary note 1, comprising
a danger degree configuring unit configured to configure, for the history information, danger degree related to degree of security risk for the terminal, wherein
the transmission control unit is configured to control the timing for the transmitting, based on the danger degree configured for the history information.

### (Supplementary Note 3)

The information collection control apparatus according to supplementary note 2, wherein the danger degree configuring unit is configured to configure, when the history information includes a parameter indicating an abnormal value, a value indicating that there is a security risk for the terminal as the danger degree.

### (Supplementary Note 4)

The information collection control apparatus according to supplementary note 2 or 3, wherein the danger degree configuring unit is configured to configure, when the history information includes attack related information related to a pattern of an attack on the terminal, a value indicating that there is a security risk for the terminal as the danger degree.

### (Supplementary Note 5)

The information collection control apparatus according to supplementary note 3 or 4, wherein the transmission control unit is configured to transmit, when a value configured for the history information as the danger degree and indicating that there is a security risk for the terminal is equal to or greater than a first value, the history information to the server.

### (Supplementary Note 6)

The information collection control apparatus according to any one of supplementary notes 3 to 5, wherein the transmission control unit is configured to transmit, when a total of values configured for the history information as the danger degree and indicating that there is a security risk for the terminal is equal to or greater than a second value, the history information to the server.

### (Supplementary Note 7)

The information collection control apparatus according to any one of supplementary notes 2 to 6, wherein
the history information collecting unit is located in a normal region,
the transmission control unit and the danger degree configuring unit are located in a protected region which is more secure than the normal region, and
the information collection control apparatus comprises
a history information receiving unit located in the protected region and configured to receive the history information from the history information collecting unit.

### (Supplementary Note 8)

The information collection control apparatus according to any one of supplementary notes 2 to 7, wherein
the history information collecting unit is configured to collect, as the history information, a collection target operation history determined as a collection target in advance, in the operation history, and
the information collection control apparatus comprises
a history information collection control unit configured to cause the history information collecting unit to execute the collection processing with a related operation history related to the collection target operation history as the collection target, in the operation history.

### (Supplementary Note 9)

The information collection control apparatus according to supplementary note 8, wherein the history information collection control unit is configured to exclude, when the related operation history is no longer related to the collection target operation history, the related operation history from the collection target.

### (Supplementary Note 10)

The information collection control apparatus according to supplementary note 8 or 9, wherein the collection target operation history includes an operation history indicating that there is a security risk for the terminal.

### (Supplementary Note 11)

The information collection control apparatus according to any one of supplementary notes 8 to 10, wherein the history information collection control unit is configured to control execution of the collection processing by the history information collecting unit, based on received information received from the server.

### (Supplementary Note 12)

The information collection control apparatus according to any one of supplementary notes 8 to 11, wherein the history information collection control unit is located in a protected region which is more secure than a normal region.

### (Supplementary Note 13)

The information collection control apparatus according to any one of supplementary notes 1 to 12, wherein the transmission control unit is configured to transmit, when an amount of the history information collected by the history information collecting unit is equal to or greater than a predetermined amount, the history information to the server.

### (Supplementary Note 14)

The information collection control apparatus according to any one of supplementary notes 1 to 13, wherein the transmission control unit is configured to transmit the history information to the server every predetermined period.

### (Supplementary Note 15)

The information collection control apparatus according to any one of supplementary notes 1 to 14, wherein the transmission control unit is configured to transmit, when the history information is the operation history in a predetermined time period, the history information to the server.

### (Supplementary Note 16)

The information collection control apparatus according to any one of supplementary notes 1 to 15, wherein the transmission control unit is configured to transmit, when the history information is a predetermined system call, the history information to the server.

### (Supplementary Note 17)

An information collection system comprising
the information collection control apparatus according to any one of supplementary notes 1 to 16.

### (Supplementary Note 18)

An information collection control method comprising:
performing collection processing for collecting history information related to an operation history of a program operating with a terminal; and
controlling a timing for transmitting the history information to a server.

### (Supplementary Note 19)

An information collection control program causing a processor to execute:
performing collection processing for collecting history information related to an operation history of a program operating with a terminal; and
controlling a timing for transmitting the history information to a server.

### INDUSTRIAL APPLICABILITY

It is possible to reduce processing load when analyzing a security risk.

### REFERENCE SIGNS LIST

1, 4, 5 Device
1A Information Collection Control Apparatus
2 Server
3 Network
11 Central Processing Unit (CPU)
12 Read Only Memory (ROM)
13 Random Access Memory (RAM)
14 Storage Medium
15 Interface (I/F)
16 Bus
17 Input Unit
18 Display Unit
100 Controller
101 Network I/F
102 Normal Region
103 Protected Region
110, 110A History Information Collecting Unit
120, 120A, 120B, 120C, 120D History Information
130 History Information Data Base (DB)
131 History Information Data Table
140 Danger Degree Configuring Unit
150, 150A Transmission Control Unit
151 History Information Data Table
160 Danger Degree Configuration Data Base (DB)
163 Danger Degree Information Data Table
170 History Information Receiving Unit
180 History Information Collection Control Unit
200 Controller
201 Network I/F
210 History Information Receiving Unit
220 History Information Data Base (DB)
230 History Information Analyzing Unit
240 History Information Collection Control Unit
1000, 1000A Information Collection System

What is claimed is:

1. An information collection control apparatus comprising:
a memory storing instructions; and
one or more processors configured to execute the instructions to:
perform collection processing for collecting history information related to an operation history of a program operating with a terminal; and
control a timing for transmitting the history information to a server.

2. The information collection control apparatus according to claim 1, wherein the one or more processors are configured to execute the instructions to:
configure, for the history information, danger degree related to degree of security risk for the terminal, and
control the timing for the transmitting, based on the danger degree configured for the history information.

3. The information collection control apparatus according to claim 2, wherein the one or more processors are configured to execute the instructions to configure, when the history information includes a parameter indicating an abnormal value, a value indicating that there is a security risk for the terminal as the danger degree.

4. The information collection control apparatus according to claim 2, wherein the one or more processors are configured to execute the instructions to configure, when the history information includes attack related information related to a pattern of an attack on the terminal, a value indicating that there is a security risk for the terminal as the danger degree.

5. The information collection control apparatus according to claim 3, wherein the one or more processors are configured to execute the instructions to transmit, when a value configured for the history information as the danger degree and indicating that there is a security risk for the terminal is equal to or greater than a first value, the history information to the server.

6. The information collection control apparatus according to claim 3, wherein the one or more processors are configured to execute the instructions to transmit, when a total of values configured for the history information as the danger degree and indicating that there is a security risk for the terminal is equal to or greater than a second value, the history information to the server.

7. The information collection control apparatus according to claim 2, wherein
at least one processor configured to perform the collection processing among the one or more processors is located in a normal region,
at least one processor configured to control the timing and to configure the danger degree are located in a protected region which is more secure than the normal region, and
the at least one processor, located in the protected region, is configured to receive the history information from the history information collecting unit.

8. The information collection control apparatus according to claim 2, wherein the one or more processors are configured to execute the instructions to:
collect, as the history information, a collection target operation history determined as a collection target in advance, in the operation history, and
perform the collection processing with a related operation history related to the collection target operation history as the collection target, in the operation history.

9. The information collection control apparatus according to claim 8, wherein the one or more processors are configured to execute the instructions to exclude, when the related operation history is no longer related to the collection target operation history, the related operation history from the collection target.

10. The information collection control apparatus according to claim 8, wherein the collection target operation history includes an operation history indicating that there is a security risk for the terminal.

11. The information collection control apparatus according to claim 8, wherein the one or more processors are configured to execute the instructions to control execution of the collection processing by the history information collecting unit, based on received information received from the server.

12. The information collection control apparatus according to claim 8, wherein the at least one processor configured to perform collection processing is located in a protected region which is more secure than a normal region.

13. The information collection control apparatus according to claim 1, wherein the one or more processors are configured to execute the instructions to transmit, when an amount of the collected history information is equal to or greater than a predetermined amount, the history information to the server.

14. The information collection control apparatus according to claim 1, wherein the one or more processors are configured to execute the instructions to transmit the history information to the server every predetermined period.

15. The information collection control apparatus according to claim 1, wherein the one or more processors are configured to execute the instructions to transmit, when the history information is the operation history in a predetermined time period, the history information to the server.

16. The information collection control apparatus according to claim 1, wherein the one or more processors are configured to execute the instructions to transmit, when the history information is a predetermined system call, the history information to the server.

17. An information collection system comprising
the information collection control apparatus according to claim 1.

18. An information collection control method comprising:
performing collection processing for collecting history information related to an operation history of a program operating with a terminal; and
controlling a timing for transmitting the history information to a server.

19. A non-transitory computer readable recording medium storing a program causing a processor to execute:
performing collection processing for collecting history information related to an operation history of a program operating with a terminal; and
controlling a timing for transmitting the history information to a server.
